(19) United States
(12) Patent Application Publication
(10) Pub. No.: US 2026/0236836 A1
(43) Pub. Date: Aug. 13, 2026

(54) SPATIOTEMPORAL TRANSFER MACHINE LEARNING

(71) Applicant: NEC Laboratories Europe GmbH, Heidelberg (DE)

(72) Inventors: Celia GARRIDO HIDALGO, Heidelberg (DE); Gurkan SOLMAZ, Heidelberg (DE); Tobias JACOBS, Heidelberg (DE)

(21) Appl. No.: 19/160,061

(22) PCT Filed: Jan. 29, 2024
(86) PCT No.: PCT/IB2024/050790

§ 371 Date: Aug. 27, 2025

Related U.S. Application Data
(60) Provisional application No. 63/536,110, filed on Sep. 1, 2023.

(51) Int. Cl. G06N 20/00

(52) U.S. Cl. CPC G06N 20/00

(57) ABSTRACT

A computer-implemented, machine learning method for spatiotemporal transfer learning. Sectors of an area are aggregated using preprocessed data from one or more data sources. The sectors are clustered based on different representations obtained for each context feature associated with each of the sectors. One or more context features that have a higher impact on a target feature to be predicted than other context features are identified from a plurality of context features and aggregated to obtain a representation of the area. Using the representation of the area, a particular sector within each of the clustered sectors is selected based on similarity to a respective centroid of the cluster to generate a set of particular sectors. A model associated with a source sector of the set of particular sectors is trained. The method has applications including, but not limited to smart cities, public safety and energy optimization.

### CROSS-REFERENCE TO PRIOR APPLICATION

This application is a U.S. National Phase application under 35 U.S.C. § 371 of International Application No. PCT/IB2024/050790, filed on Jan. 29, 2024, and claims benefit to U.S. Provisional Application Ser. No. 63/536,110 filed on Sep. 1, 2023, the entire contents of which is hereby incorporated by reference herein. The International Application was published in English on Mar. 6, 2025 as WO 2025/046310 A1 under PCT Article 21(2).

### FIELD

The present invention relates to Artificial Intelligence (AI) and machine learning, and in particular to a method, system, data structure, computer program product and computer-readable medium for spatiotemporal transfer learning.

### SUMMARY

In an embodiment, the present invention provides a computer-implemented, machine learning method for spatiotemporal transfer learning. Sectors of an area are aggregated using preprocessed data from one or more data sources. The sectors are clustered based on different representations obtained for each context feature associated with each of the sectors. One or more context features that have a higher impact on a target feature to be predicted are identified from a plurality of context features and aggregated to obtain a representation of the area. Using the representation of the area, a particular sector within each of the clustered sectors is selected based on similarity to a respective centroid of the cluster to generate a set of particular sectors. A model associated with a source sector of the set of particular sectors is trained. The method has applications in artificial intelligence (AI) to support decision making including, but not limited to use cases in smart cities (e.g., livability indices, traffic management), public safety (e.g., disaster prediction and planning), medicine/healthcare and energy optimization.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates an existing approach for transfer learning for districts context-enrichment;

FIG. 2 schematically illustrates a method and system for hexagonal transfer learning with hexagon-based clustering according to an embodiment of the present invention;

FIG. 3 schematically illustrates a source hexagon selection process for different clusters according to an embodiment of the present invention;

FIG. 4 illustrates a transfer learning problem space linked to a solution-space categorization framework;

FIG. 5 illustrates a proposal of verticals where urban transfer learning could be demonstrated;

FIG. 6 illustrates a ‘Smart Beestrict’ that creates an abstract city-boundary representation based on hexagonal regions to improve machine learning model transferability

FIG. 7 illustrates the locations of air pollution sensor stations in the city of Madrid, Spain;

FIG. 8 illustrates the mapping of air pollution measurement stations from different European cities to a hexagonal reference grid;

FIG. 9 illustrates the location of available data in the city of Madrid, Spain;

FIG. 10 illustrates the spatial interpolation of weather data using inverse distance weighting;

FIG. 11 illustrates multivariate time series data from a single hexagon after data preprocessing and aggregation;

FIG. 12 illustrates the selection of the optimal number of wind-speed clusters based on Silhouette scores;

FIG. 13 illustrates the clustering of Madrid's hexagons according to different features;

FIG. 14 illustrates mean squared error compared to variance;

FIG. 15 illustrates R² scores for different source hexagons and all target hexagons;

FIG. 16 illustrates multi-variate time series clustering aggregation on top of hexagons;

FIG. 17 illustrates R² scores for the random forest model being transferred from all source hexagons to different subsets of hexagons;

FIG. 18 illustrates mean squared error compared to variance;

FIG. 19 illustrates the clusters identified for transfer learning in the city of Madrid, Spain;

FIG. 20 illustrates the NO₂ knowledge increase in the city of Madrid after transfer learning (from 20.87% to 42.85%); and

FIG. 21 is a block diagram of an exemplary processing system, which can be configured to perform any and all operations disclosed herein.

### DETAILED DESCRIPTION

Embodiments of the present invention provide a method and AI system for the transfer of prediction models across geographical regions. The AI system provides a solution for geographic areas including urban areas with spatiotemporal data, where knowledge from one geographic area is transferred to another geographic area to make machine learning predictions. The AI system utilizes a new method which is referred to herein also as “hexagonal transfer learning”.

Properties of geographical regions are typically measured by a sensor infrastructure. Once a sensor has been installed at a location, it provides measurements of some property in a high time resolution. However, achieving a high spatial resolution of the property is very costly, both in terms of physical and computational resources, because many sensors need to be installed in the region of interest, causing the hardware, labor, and energy costs to increase with the spatial resolution. Furthermore, technical, legal, and other constraints limit the ability to deploy dense networks of sensors.

Embodiments of the present invention provide solutions to the technical problem of lack of spatial resolution of the sensor infrastructure using an approach based on transfer learning. Machine learning models can be used to predict the property of interest on a high spatial resolution despite the unavailability of sensors. Due to the absence of ground truth in a region without a sensor, prediction models can be trained outside the region and then transferred.

In a first aspect, the present invention provides a computer-implemented, machine-learning method for spatiotemporal transfer learning. Sectors of an area are aggregated using preprocessed data from one or more data sources. The sectors are clustered based on different representations obtained for each context feature associated with each of the sectors. One or more context features that have a higher impact on a target feature to be predicted are identified from a plurality of context features and aggregated to obtain a representation of the area. Using the representation of the area, a particular sector within each of the clustered sectors is selected based on similarity to a respective centroid of the cluster to generate a set of particular sectors. A model associated with a source sector of the set of particular sectors is trained.

In a second aspect, the present invention provides the method according to the first aspect, wherein training the model includes training a plurality of models associated with the source sector and/or using ground truth data of the source sector, the method further comprising: identifying one of the models with a highest accuracy from the plurality of models using cross-validation; and updating the trained model associated with the source sector using shifting based on existing urban-form factors and/or seasonal shifting using time-dependent events.

In a third aspect, the present invention provides the method according to the first aspect or the second aspect, wherein the impact of each of the context features is determined by computing feature importance for each of the context features by applying each of the context features to one of the models and determining how much each of the context features contribute to decreasing uncertainty of the respective model.

In a fourth aspect, the present invention provides the method according to any of the first to third aspects, wherein the source sector is selected for training the model based on having a highest similarity to the respective centroid of the respective cluster associated with the source sector relative to other ones of the particular sectors that have ground truth data.

In a fifth aspect, the present invention provides the method according to any of the first to fourth aspects, further comprising predicting, using the trained model, the target feature for one of the sectors that is different from the source sector and does not have ground truth data.

In a sixth aspect, the present invention provides the method according to any of the first to fifth aspects, wherein data in the one or more data sources is obtained via a web crawling service or device discovery.

In a seventh aspect, the present invention provides the method according to any of the first to sixth aspects, wherein the target feature and the context features that are identified and aggregated to obtain the representation of the area are each related to air quality of the area.

In an eighth aspect, the present invention provides the method according to any of the first to seventh aspects, wherein the data is preprocessed by at least checking the language and format of the data, performing temporal data augmentation to the data, and performing spatial augmentation of the context data.

In a ninth aspect, the present invention provides the method according to any of the first to eighth aspects, wherein the sectors of the area are identified based on a geographical location of a sensor device, each of the sectors representing geometrical boundaries for the area.

In a tenth aspect, the present invention provides the method according to any of the first to ninth aspects, wherein clustering the sectors is further based on a maximum number of clusters to iterate and a similarity metric for computing Silhouette scores.

In an eleventh aspect, the present invention provides the method according to any of the first to tenth aspects, wherein selecting the particular sector within each cluster of the clustered sectors is further based on scaling different time series data inside each clustered sector, computing a Silhouette score for each sector of each clustered sector, determining the centroid for each cluster based on scaled context data, and selecting the particular sector within a certain distance of the centroid for the cluster based on the Silhouette score for the particular sector.

In a twelfth aspect, the present invention provides the method according to any of the first to eleventh aspects, wherein the data from the one or more data sources includes sensor data from one or more sensors geographically located within the area.

In a thirteenth aspect, the present invention provides the method according to any of the first to twelfth aspects, wherein the preprocessed data includes a common format and sampling frequency from one or more data sources.

In a fourteenth aspect, the present invention provides a computer system for spatiotemporal transfer learning comprising one or more processors, which, alone or in combination, are configured to perform a machine learning method for spatiotemporal transfer learning according to any of the first to thirteenth aspects.

In a fifteenth aspect, the present invention provides a tangible, non-transitory computer-readable medium for spatiotemporal transfer learning which, upon being executed by one or more hardware processors, provide for execution of a machine learning method according to any of the first to thirteenth aspects.

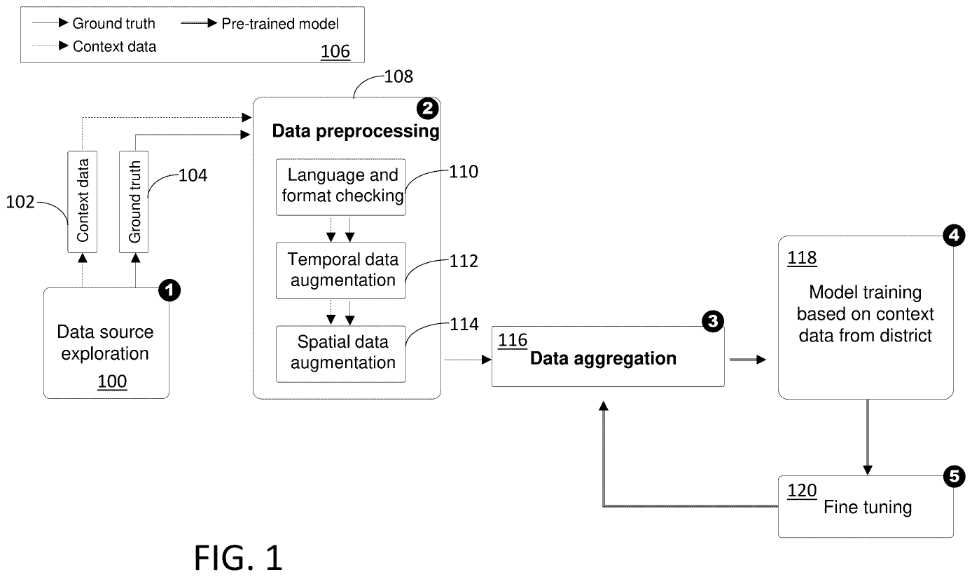

The transfer learning techniques utilized in existing technology are limited in applicability to a particular problem, as explained in the following with reference to FIG. 1, which illustrates the transfer learning approach according to existing technology, considering its applications to a spatiotemporal domain such as regions in a geographical area (e.g., districts in a city). The terms regions and districts are used herein interchangeably based on the use case. A similar transfer learning process including data preprocessing, augmentation, model training and fine tuning is described in the TensorFlow tutorial. The AI system applying the transfer learning approach according to existing technology executes the following steps:
Step 1: Data source exploration 100. The data source exploration may include context enrichment to obtain context data 102, where relevant data sources are gathered along with the ground-truth 104. FIG. 1 also includes key 106.
Step 2: Data preprocessing 108. Afterwards, data preprocessing is performed where various techniques such as filtering, scaling, normalization, interpolation, and data augmentation can be applied (in Step 2). FIG. 1 includes language and format checking 110 as well as two types of data augmentation (112 and 114) as well as format/translation as examples for data preprocessing.
Step 3: Data aggregation 116. The preprocessed data can be aggregated for different regional areas/districts.
Step 4: Model training 118. A machine learning model is trained on the preprocessed and aggregated data for a particular region/district. The model can perform predictions for the district where the data resides.
Step 5 (120)232: The machine learning model trained on one district can be transferred to another district and fine-tuned with the data from the new district.

The transfer learning techniques utilized in existing technology suffer from a number of technical limitations. For example, Ghasemi, K., Hamzenejad, M., Meshkini, A., “The spatial analysis of the livability of 22 districts of Tehran Metropolis using multi-criteria decision making approaches,” Sustainable Cities and Society 38:382-404 (2018), which is hereby incorporated by reference herein, defined a livable urban environment as a place where the built structure promotes quality of life by supporting the basic needs of its residents. Given the lack of a universally-agreed measurement methodology for a livability index, it is typically broken down into different sub-domains according to social, economic or environmental factors, among others (see Khorrami, Z., Ye, T., Sadatmoosavi, A., Mirzaee, M., Fadakar Davarani, M. M., Khanjani, N., “The Indicators and Methods used for Measuring Urban Livability: A Scoping Review,” Reviews on Environmental Health 36(3):397-441 (2021), which is hereby incorporated by reference herein.

In the environmental domain, the deployment of air-quality monitoring sensors is not a trivial task since, apart from being relatively expensive compared to binary digital sensors, they require as well human expertise for warm-up and calibration. These resources, unfortunately, are not always available in resource-constrained environments. While the prediction of air quality has been addressed based on either environmental sensor data or context information, only a few transfer learning-oriented approaches exist to date (see Jha, S., Kumar, M., Arora, V., Tripathi, S. N., Motiram Motghare, V., Shingare, A., Singh Rajput, Kamble, S., “Domain adaptation based deep calibration of low-cost PM2.5 sensors,” IEEE Sensors Journal, doi:10.36227/techrxiv.15276186 (2021); and Honarvar, A. R., Sami, A., “Towards Sustainable Smart City by Particulate Matter Prediction Using Urban Big Data, Excluding Expensive Air Pollution Infrastructures,” Big Data Research 17:56-65 (2018), each of which is hereby incorporated by reference herein).

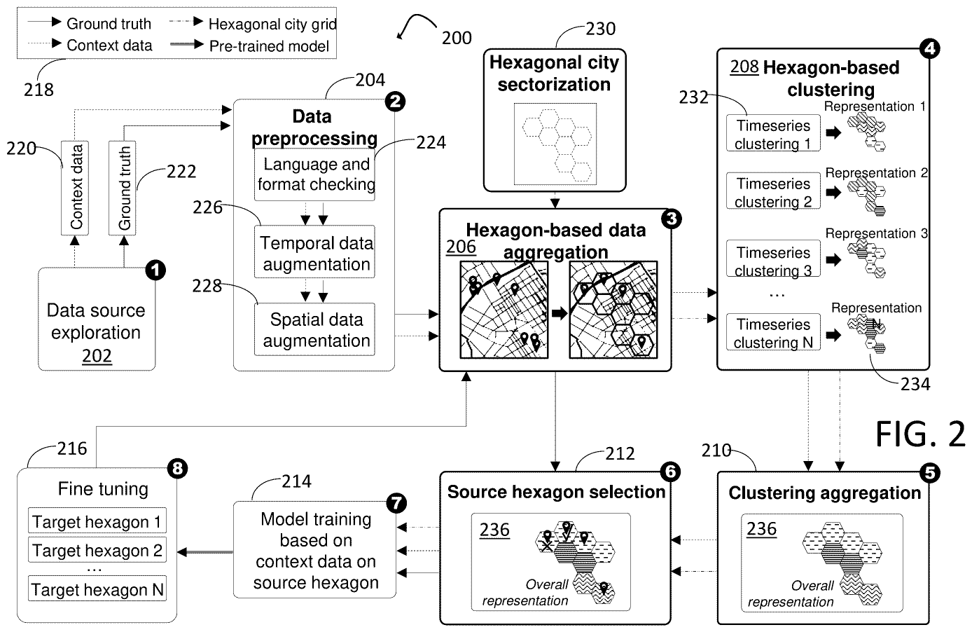

FIG. 2 illustrates a hexagonal transfer learning method 200 according to an embodiment of the present invention, introducing the following components: data source exploration step 1 (202), data preprocessing step 2 (204), hexagon-based data aggregation step 3 (206), hexagon-based clustering step 4 (208), clustering aggregation step 5 (210), source hexagon selection step 6 (212), model training based on context data on source hexagon step 7 (214), and fine tuning step 8 (216). The embodiment of FIG. 2 using a hexagonal grid represents one exemplary and advantageous embodiment of the present invention. In other embodiments, the method can also be advantageously applied to other regular or irregular structures of geographical areas or objects, including physical objects like buildings or road segments. FIG. 2 also includes key 218. The method includes the following steps:
Step 1: Data source exploration 202. This step includes exploration of available data sources: Gathering of all available data sources of a reference region where different data sources that may or may not be publicly available. This step can be performed automatically (e.g., through web crawling or service/device discovery). Among the data sources, those that are collected from a higher variety of locations will be used as context data 220 for model training, while those with more limited availability will be selected as a target feature to be predicted (ground truth 222) in regions lacking measurement stations.
Step 2: Data preprocessing 204. This step represents the required processing of all data sources (context data 220 and ground truth 222) to guarantee a common format and sampling frequency. To do so, three baseline steps are: (i) language and format checking 224, (ii) temporal data augmentation 226, and (iii) spatial augmentation of context data used for training 228, when possible, so as to guarantee all studied regions share a common feature space.
Step 3: Hexagon-based data aggregation 206. This step is built upon a hexagonal area (e.g., city area) sectors 230 provided as a grid with a certain resolution, which represent the geometrical boundaries that will be used from this point on to identify city hexagons as independent entities. The hexagonal areas may be obtained from software libraries. Aggregation is provided for by mapping the location of each measurement station to their respective hexagon identifier and, then, computing the mean of all measurement stations included at the hexagon level. The resulting time series will be used as a reference for both context data and ground truth data, which is predicted at the hexagon level to maintain the same level of granularity across all regions, in contrast to district-oriented approaches.
Step 4: Hexagon-based clustering (single-variate) 208. Embodiments of the present invention advantageously enable the identification of relevant context features, at the hexagon level, that can be potentially used for time series clustering 232 the different regions with context data available. As a result, different city representations 234 can be obtained for each of the context features available at the hexagon level, such as temperature, humidity, or traffic in the case of air quality prediction. The different shadings of the hexagons for the different city representations 234 indicate different cluster identifiers. Hexagons with the same shading are considered part of the same cluster. This mechanism can be automated so that, for a given city, a series of feature-oriented representations indicating a positive or a negative impact on local air quality can be obtained. Silhouette score can be used to select the optimal number of clusters. Once identified, the timeseries centroid of each cluster is computed, which is used in the next steps for selecting a suitable training hexagon within each cluster.
Step 5: Cluster aggregation 210: This step performs multivariate hexagon-based cluster aggregation. Based on the obtained context-oriented representations of the sectorized region model, a set of relevant features having a higher impact on the target feature being predicted (e.g., NO₂ concentration) can be identified. The degree of impact for each of the features can be determined by evaluating a predictive accuracy of a transferred model after transfer according to each feature of the set of relevant features to determine feature importance for each of the features. The obtained representations for each of the features are then aggregated to obtain a final representative number of districts at the region level, for which different alternatives can be considered, such as computing the intersection of all representations or weighting them according to different feature importance identified in a hexagon with ground truth data available. In one or more embodiments, the feature importance may be calculated using a decision tree, random forest, or forest of trees method where feature importance is determined by how much each feature contributes to reducing the uncertainty in the target variable. In a random forest scenario, feature importance may be calculated as the decrease in node impurity weighted by the probability of reaching that node. The node probability can be calculated by the number of samples to reach the node, divided by the total number of samples. The higher the value the more important the feature. Permutation feature importance may be defined to be a decrease in a model score when a single feature value is randomly shuffled. This procedure breaks the relationship between the feature and the target, thus a drop on the model score is indicative of how much the model depends on the feature. The resulting representation 236 indicates that a model trained with ground truth data from a given hexagon (source) will be potentially transferable to hexagons belonging to the same district. Algorithm 1 includes an example implementation of the multivariate hexagon-based clustering aggregation step as a function of obtained single-variate timeseries clusters in the city. The algorithm uses as an input the aggregated multivariate timeseries data (including both air quality and context data), the maximum number of clusters to iterate, and the required similarity metric for computing Silhouette scores (e.g., Euclidean distance). In embodiments, the maximum number of clusters to iterate and the required similarity metric are user provided. The first ‘forEach’ loop refers to Step 4 of (single-variate) hexagon-based clustering where the optimum number of clusters and their respective timeseries centroids are obtained on top of the hexagonal city representation. The second ‘forEach’ loop applies a given cluster aggregation strategy to obtain the final context-base city representation, where two implementation examples are provided (using feature importance or using an overall clustering intersection).

Algorithm 1
Hexagon-based time series clustering and multivariate aggregation.

input: N_{clust}_{_{—}}ₘₐₓ, metricₛᵢₘᵢₗ, hexagons, strat, mag_{aggr} forEach mag in ts[ ] context_magnitudes_{aggr}
output: ts[ ] clusters_{aggr}
forEach mag_{aggr} ! = target do:
| N_{clust}_{_{—}}ₒₚₜ, Sₘₑₐₙ = −1
| for N_{c} in N_{clust}_{_{—}}ₘₐₓ do:
| | ts[ ] centroids_{aggr}, int[ ] silhouette_{aggr}, int[ ] C ← TimeSeriesKMeans(N_{clust}, metricₛᵢₘᵢₗ, mag_{aggr})
| | if mean(silhouette_{aggr}) > Sₘₑₐₙ and silhouette_{aggr}[N_{clust}_{ᵢ}] > mean(silhouette_{aggr}) for N_{c}_{ᵢ}in N_{c} do:
| | | N_{clust}_{_{—}}ₒₚₜ, Sₘₑₐₙ = N_{c}, mean(silhouette_{aggr})
| └ └ cluster_{mag} ← C
└ append cluster_{mag} to int[ ] clustersₒₚₜ
forEach hex in hexagons do:
| forEach mag_{aggr} ! = target do:
| | if strat is ‘feature_importance’ do:
| | └ int[ ] W ← weigh_clusters(feature_importance(mag_{aggr}))
| | clusters_{aggr} ← sum(W)
| | else if strat is ‘intersect’ do:
└ └ └ clusters_{aggr} ← hex_{subset} where hex belong to same cluster

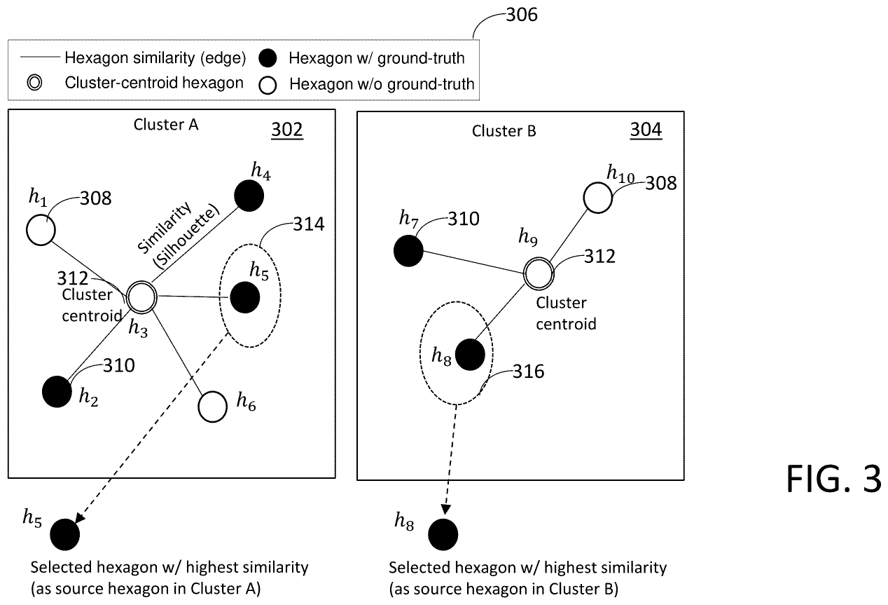

Step 6: Source hexagon selection 212. Once identified, the different districts in one (or multiple) regions (e.g., cities) including more than one hexagon with ground truth data available are studied in further detail so that the hexagon with the highest similarity to its respective cluster centroid is selected for training the source model. For this, an embodiment of the present invention uses Silhouette scores, which can be done in a semi-automated manner based on the following steps: (i) scaling the different time series data inside each aggregated cluster representation, (ii) computing the Silhouette score of all hexagons inside each cluster, (iii) obtaining the cluster centroid according to scaled context data, and (iv) selecting the ground truth hexagon that has the highest similarity to the cluster's centroid based on the similarity (given by the Silhouette score). FIG. 3 illustrates this process for the source hexagon selection. In FIG. 3, nodes represent all the hexagons in the given clusters and edges represent the similarity obtained between the cluster centroid and the all other hexagons in the cluster. FIG. 3 depicts two clusters, Cluster A 302 and Cluster B 304 as well as key 306. For Clusters A and B 302 and 304, FIG. 3 includes hexagons without a ground-truth 308 as well as hexagons with a ground-truth 310. FIG. 3 depicts cluster centroids 312 for Cluster A 302 and Cluster B 304. FIG. 3 also depicts a selected source hexagon 314 and 316 for each cluster 302 and 304, respectively. As described herein, out of all available hexagons which have ground-truth data, the one with the highest similarity (Silhouette score) to the cluster-centroid hexagon is selected as a “source hexagon” (314 and 316) to be used.
Step 7: Model training 214: Having selected the source hexagon, different models are trained and tested as a means to automatically identify those with the highest accuracy through cross-validation. Cross-validation, as used herein, may refer to a process in machine learning where a part of the data is not used for model training but for validating the performance of the trained model. By doing this for several different trained models, the models can be compared and the best one can be selected. From this, one or more hexagons with ground truth data are identified, of which one will be selected for model training due to having the highest similarity to the remaining ones. This is done by selecting the ground truth hexagon that has the highest similarity to the cluster's centroid based on the similarity (given by the Silhouette score).
Step 8: Fine tuning 216. Once every cluster model is trained, it can be fine-tuned at the target hexagon through: (i) constant shifting (e.g., adding or subtracting a fixed value) based on existing urban-form factors such as parks or industrial areas, and (ii) seasonal shifting (e.g., adding or subtracting a value at times of specific events) based on time-dependent events such as, for cities, festivals or national holidays.

In addition to providing for general improvements to computers used in AI systems to provide enhanced functionality for spatiotemporal transfer learning, embodiments of the present invention can be practically applied to a number of use cases to effect further improvements in a number of technical fields, such as smart cities, smart agriculture, smart industrial plants, public safety, automated traffic control, and other machine learning tasks utilizing spatiotemporal data, for example, by being able to provide more accurate predictions to support decision making and reducing a required sensor infrastructure.

In an exemplary embodiment, the present invention can be applied to a use case for smart cities for providing a “City Livability Index” (CLI), which is used to quantify livability-related metrics of cities using sensor data, open data and/or machine learning predictions, such that different districts in the city may have different indices. For instance, a district can have higher air quality in comparison to other districts, whereas it may have more limited public transportation options. The spatiotemporal transfer learning according to an embodiment of the present invention can be applied, for example, in the urban domain, such as in the urban transfer learning approaches.

In an exemplary embodiment, the present invention can be applied to a use case for urban transfer learning (UTL). In contrast to the current state of existing technology in the UTL domain, different vertical solutions are provided according to embodiments of the present invention. To do so, the CLI is first defined as a framework for the proposal of urban planning strategies based on the transferability of prediction models. In the context of urban transfer learning in smart cities, embodiments of the present invention provide three reusability-oriented verticals encompassed in a given region that leverage cross-district and cross-modality transfer methods, specifically:
1. Cross-district (CD). This vertical is expected to demonstrate the highest reusability index for air quality predictions across different city sectors. Hence, it represents a transductive transfer learning problem, where the same learning task (TS=TT) is carried out in different domains represented by the contextual information available for the source (DS) and origin (DT) city sectors. In this case, similar marginal probability distributions and feature spaces are expected to exist (PS (X)~PT (X) and XS~XT) in both source and target sectors.
2. Cross-cluster district (CC). This vertical serves to validate the feasibility of the proposed two-step clustering approach. In this case, a transductive transfer learning approach is used where, in contrast, the feature spaces and/or the marginal distributions between source and target domains are not expected to be similar.
3. Cross-modality (CM). This vertical corresponds to an inductive transfer learning approach, where instance data from the same domain can be reused to learn a different but related task. In this case, the domain (DS=DT) is represented by a specific city sector, while the proposed example tasks for knowledge transferability are air quality prediction (TS) and noise pollution prediction (TT). Therefore, the feature spaces, in this case, are expected to differ from source to target tasks.

Some of the improvements in the different technical fields of application and technical advantages for the applications, such as the urban applications, include (but are not limited to) the following:
Air quality: Air quality predictions for urban or agricultural areas with sensor information and transfer learning prediction for data such as NO₂, O₃, PM2.5, PM10, CO₂, etc. This would enable assessing the problems in air quality, creating alarms/warnings, understanding underlying factors and planning districts accordingly. Implementation of the method according to an embodiment of the present invention would allow data availability in all areas as opposed to only certain area.
Disaster preparedness: Implementation of the method according to an embodiment of the present invention would enable estimating disaster preparedness and problems with certain “disaster preparedness indices” such as risk of flood occurrence in terms of the affected population. The AI system according to an embodiment of the present invention could help train on districts where relevant data is missing.
Energy management: The energy efficiency of the districts can be quantified by the energy-related indices. These quantities can be given or estimated using the transfer learning method and system according to an embodiment of the present invention. Energy efficiency given different resolutions can help automatically adapt the relevant systems (e.g., mobility systems) and help district planners to realize positive energy district.

Oscar Almström, Erik Carlsson, Daniel Cronqvist, Max Karlsson, Fredrik Lilliecreutz, Alexander Viala Bellander, “Fleet Management Optimisation with Spatio-Temporal Demand Forecasting in MaaS for Free-floating Micro-mobility,” Bachelor's thesis in Computer Science and Engineering, Chalmers University of Technology, Gothenburg, Sweden (2021), which is hereby incorporated by reference herein, present a demand forecasting approach for mobility. In contrast to embodiments of the present invention, the authors do not describe or use any transfer learning approach at all, and instead merely describe to try to optimize a global model.

Richard Arthur McAllister, “Extracting Abstract Spatio-temporal Features of Weather Phenomena for Autoencoder Transfer Learning,” dissertation, Montana State University (2020), which is hereby incorporated by reference herein, describe a transfer learning approach with an autoencoder with neural network layers that is trained for one instance (a hurricane). Some of the layers of the neural network are transferred to a new dataset (a new hurricane), and fine-tuned (or not fine-tuned) based on the new dataset. Thus, this approach is based on a neural network parameter transfer. In contrast, embodiments of the present invention provide for a machine learning model that is agnostic of the end model and are based on a new and improved transfer learning approach based on spatially-clustered regions and their comparisons. Furthermore, embodiments of the present invention provide to make decisions whether to apply on a certain region or not, in contrast to trying to apply in any data that is spatially distant.

U.S. Patent Application Publication No. 2017/0293635 describes a system that is based on geospatial data and grids that are used on it. The system provides different ways of aggregation of data and querying either local or aggregated data/statistics. In contrast to embodiments of the present invention, there is no description or use of any transfer learning approach at all, nor anything similar.

In an embodiment, the present invention provides a method for spatiotemporal transfer machine learning, the method comprising:
1) Exploration of available data sources.
2) Data preprocessing.
3) Data aggregation.
4) Hexagon-based multivariate clustering: Clustering by different representations obtained for each of the context features available at the hexagon.
5) Clustering aggregation: Identifying relevant context features with higher impact on the target feature, to be used in the transfer learning source hexagon decisions.
6) Obtaining a representative model for each cluster by training a model for the centroid of each cluster: Source hexagon selection by Silhouette scores and choosing hexagon-cluster-centroid. For example: 1) a representative hexagon is selected in the hexagon cluster, called a cluster centroid; 2) the similarity scores with the centroid and other hexagons in the cluster are calculated (e.g., by Silhouette score); 3) the hexagon with the highest similarity is selected as the source hexagon—similar to the description of FIG. 3 above.
7) Machine learning model fine-tuning for the new hexagons.

As already mentioned above, the hexagonal grid structure represents an exemplary, advantageous embodiment. The method can be correspondingly applied in other embodiments independent of the particular geographical object structure(s) or area(s). Other regular (e.g., grid-like) or irregular (e.g., buildings, road segments) object structures can be utilized as well. The following improvements also apply independent of the particular geographical object structure(s) or area(s).

Embodiments of the present invention provide for the following improvements and technical advantages over existing technology:
1) Hexagon-based multivariate clustering: Clustering by different representations obtained for each of the context features available at the hexagon.
2) Clustering aggregation: Identifying relevant context features with higher impact on the target feature, to be used in the transfer learning source hexagon decisions.
3) Obtaining a representative model for each cluster by training a model for the centroid of each cluster: Source hexagon selection by Silhouette scores and choosing hexagon-cluster-centroid.
4) Transferring knowledge between districts to be used for planning/optimizing districts.
5) Providing regional insights through predictions for the hexagonal areas with missing data or knowledge.

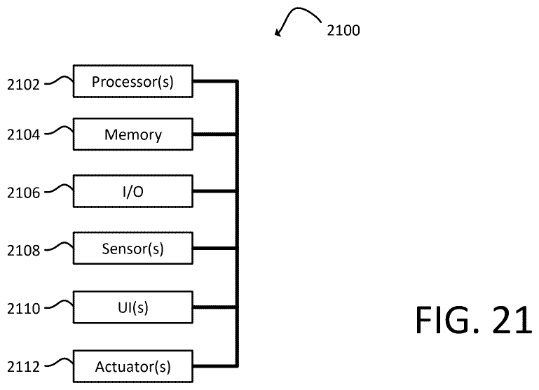

Referring to FIG. 21, a processing system 2100 can include one or more processors 2102, memory 2104, one or more input/output devices 2106, one or more sensors 2108, one or more user interfaces 2110, and one or more actuators 2112. Processing system 2100 can be representative of each computing system disclosed herein.

Processors 2102 can include one or more distinct processors, each having one or more cores. Each of the distinct processors can have the same or different structure. Processors 2102 can include one or more central processing units (CPUs), one or more graphics processing units (GPUs), circuitry (e.g., application specific integrated circuits (ASICs)), digital signal processors (DSPs), and the like. Processors 2102 can be mounted to a common substrate or to multiple different substrates.

Processors 2102 are configured to perform a certain function, method, or operation (e.g., are configured to provide for performance of a function, method, or operation) at least when one of the one or more of the distinct processors is capable of performing operations embodying the function, method, or operation. Processors 2102 can perform operations embodying the function, method, or operation by, for example, executing code (e.g., interpreting scripts) stored on memory 2104 and/or trafficking data through one or more ASICs. Processors 2102, and thus processing system 2100, can be configured to perform, automatically, any and all functions, methods, and operations disclosed herein. Therefore, processing system 2100 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 2100 can be configured to perform task “X”. Processing system 2100 is configured to perform a function, method, or operation at least when processors 2102 are configured to do the same.

Memory 2104 can include volatile memory, non-volatile memory, and any other medium capable of storing data. Each of the volatile memory, non-volatile memory, and any other type of memory can include multiple different memory devices, located at multiple distinct locations and each having a different structure. Memory 2104 can include remotely hosted (e.g., cloud) storage.

Examples of memory 2104 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 2104.

Input-output devices 2106 can include any component for trafficking data such as ports, antennas (i.e., transceivers), printed conductive paths, and the like. Input-output devices 2106 can enable wired communication via USB®, DisplayPort®, HDMI®, Ethernet, and the like. Input-output devices 2106 can enable electronic, optical, magnetic, and holographic, communication with suitable memory 2106. Input-output devices 2106 can enable wireless communication via WiFi®, Bluetooth®, cellular (e.g., LTE®, CDMA®, GSM®, WiMax®, NFC®), GPS, and the like. Input-output devices 2106 can include wired and/or wireless communication pathways.

Sensors 2108, such as cameras, air quality sensors, movement sensors, position sensors, etc., can capture physical measurements of environment and report the same to processors 2102. User interface 2110 can include displays, physical buttons, speakers, microphones, keyboards, and the like. Actuators 2112 can enable processors 2102 to control mechanical forces.

Processing system 2100 can be distributed. For example, some components of processing system 2100 can reside in a remote hosted network service (e.g., a cloud computing environment) while other components of processing system 2100 can reside in a local computing system. Processing system 2100 can have a modular design where certain modules include a plurality of the features/functions shown in FIG. 21. For example, I/O modules can include volatile memory and one or more processors. As another example, individual processor modules can include read-only-memory and/or local caches.

The following provides further background and description of exemplary embodiments of the present invention, which may overlap to some extent with some of the information provided above. To the extent the terminology used to describe the exemplary embodiments may differ from the terminology used to describe the above embodiments, a person having skill in the art would understand that certain terms correspond to one another in the different embodiments. Features described in the Attachment can be combined with features described above in various embodiments.

Transfer Learning (TL) emerged in the last decade as a means of improving the reusability of ML models across different—but related—tasks and domains by enabling the partial transference of already-acquired knowledge. It represents a new learning paradigm in which, rather than focusing on the collection of labeled and unlabeled training data to learn a specific task from scratch, the reuse of previous knowledge from different tasks and domains is pursued. The intuitive idea behind TL is to exploit generalizable knowledge from models trained for a specific task where abundant labeled data is available, so that certain accuracy improvements can be achieved for related tasks (or domains) where data-annotation efforts are expensive.

The suitability of TL for computer vision has been broadly studied in the literature under energy prediction, predictive maintenance, or healthcare domains. Despite being in its relatively early development stage in the urban domain, it represents one of the areas where greatest insights are expected given the difficulty of collecting data related to natural phenomenon such as drought or flooding, among others. Moreover, the expensive nature of chemical sensors—such as air-quality monitors—reduces to a great extent the availability of labeled air pollution data, which is even more accentuated in sub-urban or rural areas with limited infrastructures.

The present disclosure describes the “Smart Beestricts” concept: a novel hexagon-based spatiotemporal TL solution built upon open urban-related data sources which identifies unexplored city regions with potential transferability of pretrained ML models. As an example use case, openly-available data from the city of Madrid, Spain, was used, processed and enriched (both spatially and temporally) using the features of the application described herein. Then, the “Smart Beestrict” representation of the city of Madrid was created through aggregation, multi-variate timeseries clustering of context information, and overall cluster aggregation for the discovery of reusable hexagonal regions. The example use case focuses on air quality predictions (NO₂) as the main result, which is based on the different Jupyter Notebook implementations carried out during the project execution period. However, the features of the current application are not limited to air quality predictions.

The following sections describe TL fundamentals. For example, let us define a domain [symbol] as the combination of two elements: a feature space [symbol] and a marginal probability distribution P(X), with X being a feature vector {x₁, x₂, . . . , xₙ} where xᵢ∈ [symbol] . For a given domain, it is also possible to define a series of tasks [symbol] , each of them in turn encompassing a specific label space [symbol] and predictive function ƒ(⋅) learned from feature and label vectors, that is, P(Y|X). A specific domain can, in turn, be labeled as either source or target, so that D_{S} comprises a series of data instances and labels {(xₛ_{₁},yₛ_{₁}), . . . , (xₛ_{ₙ},yₛ_{ₙ})} with xₛ_{ᵢ}∈ [symbol] and yₛ_{ᵢ}∈ [symbol] , and vice versa.

Based on the previous definitions concerning specific source ( [symbol] , [symbol] ) and target ( [symbol] , [symbol] ) spaces, TL is referred to as a learning technique aimed at helping to improve the learning of the target predictive function ƒ_{T}(⋅) in [symbol] using the knowledge in [symbol] and [symbol] , where [symbol] ≠ [symbol] , or [symbol] ≠ [symbol] .

From the previous definitions, [symbol] * [symbol] can be given by either [symbol] ≠ [symbol] or P_{S}(X)≠P_{T}(X), depending on whether source-target differences exist in the feature spaces or the marginal distributions exist. Similarly, [symbol] * [symbol] translates into either [symbol] ≠ [symbol] or ƒ_{S}(⋅)≠ƒ_{T}(⋅). Below is a table which includes TL nomenclature consensus:

| Symbol | Definition |
|---|---|
| [symbol] | Domain |
| [symbol] | Task |
| [symbol] | Feature Space |
| X | Feature vector |
| xᵢ | Feature |
| [symbol] | Label space |
| Y | Label vector |
| yᵢ | Label |
| S | Source |
| T | Target |
| P(X) | Marginal probability distribution of X |
| f(•) | Predictive function |
| P(Y\|X) | Predictive function learned from Y and X |

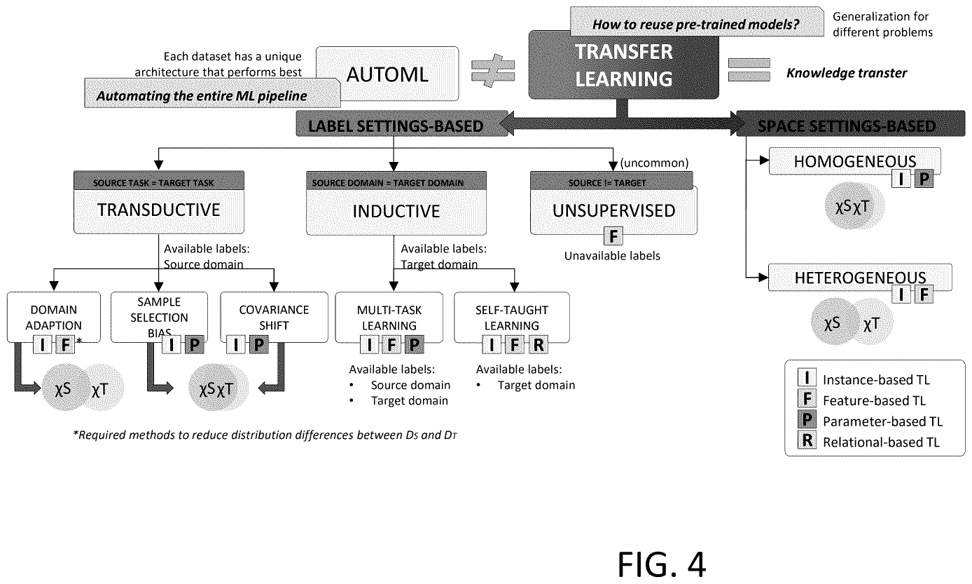

From the existing TL categorization approaches, the two with highest acceptance are the ones focusing respectively on the problem space and solution space. In the former, different TL problems are defined based on the nature of source and target data spaces while, in the latter, it is the answer to the question “what to transfer?”, which triggers the classification. FIG. 4 shows an overview of the different problem-setting categorization approaches, which are in turn interlinked with the previous solution based settings as a means to provide a unique TL categorization framework.

Based on the current state of the art in the UTL domain, different vertical solutions are described in the current disclosure. The current disclosure defines CLI, which will be used as a framework for the proposal of urban planning strategies based on the transferability of prediction models. Ghasemi et al. defined a livable urban environment as a place where the built structure promotes quality of life by supporting the basic needs of its residents. Given the lack of a universally-agreed measurement methodology for CLI, it is typically broken down into different sub-domains according to social, economic or environmental factors, among others.

In the environmental domain, the deployment of air-quality monitoring sensors is not a trivial task since, apart from being relatively expensive compared to binary digital sensors, they also require human expertise for warm-up and calibration. These resources, unfortunately, are not always available in resource-constrained environments. Only a few TL-oriented approaches exist to date for the prediction of air quality.

With this context the current disclosure provides several examples of reusability-oriented verticals encompassed in the city livability domain that leverage cross-district and cross-modality transfer methods, specifically:

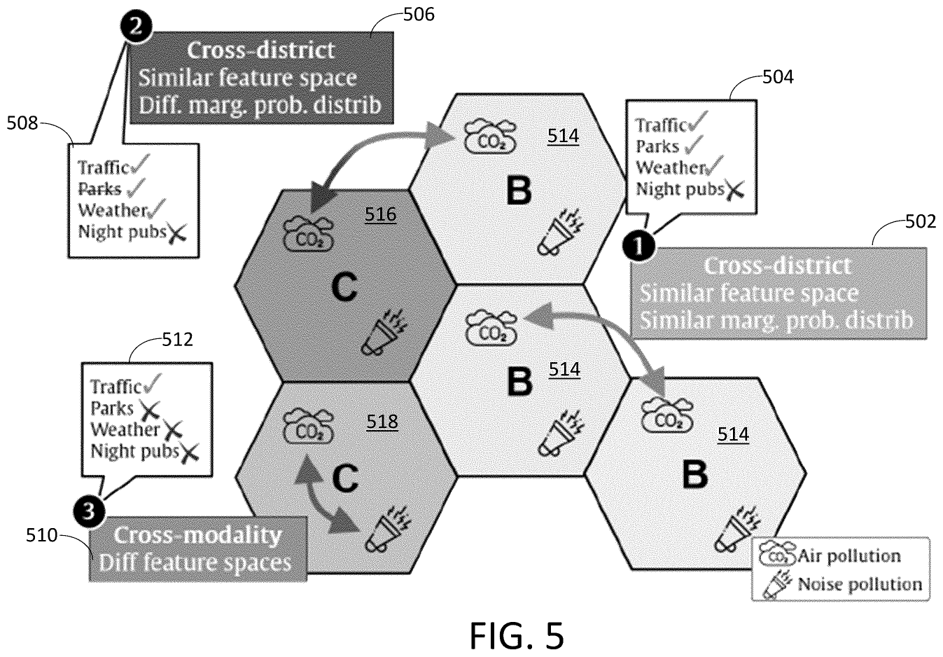

Cross-district (CD) 502. This vertical is expected to demonstrate the highest reusability index for air quality predictions across different city sectors. Hence, it represents a transductive TL problem, where the same learning task ( [symbol] = [symbol] ) is carried out in different domains represented by the contextual information available for the source ( [symbol] ) and origin ( [symbol] ) city sectors. In this case, similar marginal probability distributions and feature spaces are expected to exist (P_{S}(X)~P_{T}(X) and [symbol] ~ [symbol] ) in both source and target sectors. In FIG. 5, Cross-district 502 includes context data 504.

Cross-cluster district (CC) 506. This vertical will serve to validate the feasibility of the proposed two-step clustering approach. In this case, a transductive TL approach is utilized where, in contrast, the feature spaces and/or the marginal distributions between source and target domains are not expected to be similar. In FIG. 5, Cross-cluster district 506 includes context data 508.

Cross-modality (CM) 510. This vertical corresponds to an inductive TL approach, where instance data from the same domain can be reused to learn a different but related task. In this case, the domain ( [symbol] = [symbol] ) is represented by a specific city sector, while the proposed tasks for knowledge transferability are air quality prediction ( [symbol] ) and noise pollution prediction ( [symbol] ). The feature spaces, in this case, are expected to differ from source to target tasks. In FIG. 5, Cross-modality 510 includes context data 512. In FIG. 5 hexagons B 514 represent hexagons with a similar feature space and marginal probability distribution, hexagon C 516 represents a hexagon with a similar feature space but with different marginal probability distributions, and hexagon C 518 represents a target hexagon for predicting features based on locally-available context data.

An embodiment of the current disclosure includes a mechanism based on multi-variate time series clustering for the semi-automated discovery of city regions where a certain air quality prediction model can be potentially transferable to other city regions with little computational effort. This is described, sometimes, as the “Smart Beestrict” concept herein. FIG. 5 depicts various verticals where UTL could be used based on the mechanisms described herein.

The “Smart Beestrict” concept described herein represents a TL-oriented method for defining geographic boundaries inside cities that, instead of relying on socioeconomical aspects following the conventional district definition, focuses the discovery of hexagonal regions sharing a similar context so as to enable automatic model transferability and knowledge acquisition avoiding the use of physical sensors.

As used herein a “Smart Beestrict” is a representation of internal city boundaries composed of different hexagonal sectors that share a similar feature space and thus enable transfer of pre-trained ML models across internal hexagons for automatically extending knowledge acquired.

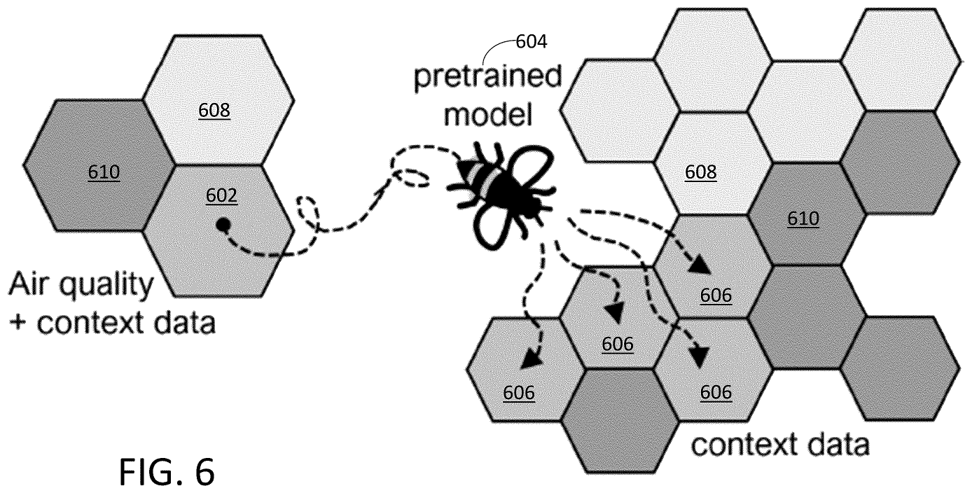

FIG. 6 depicts the applicability of the “Smart Beestrict” concept for TL across different hexagonal city regions. First, the source hexagon 602 is used for model training based on both ground-truth data (e.g., CO, NO2, or O3) and relevant context data (e.g., traffic or weather). Second, the model pre-trained 604 on source hexagon 602 for each of the air-quality features is then reused on each of the target hexagons 606 enabling air-quality predictions based on locally-available context data. The union of all hexagons sharing a common context is referred to as “Smart Beestrict,” which is automatically identified through time series clustering of context-related features. Hexagons 608 represent hexagons with a similar feature space and marginal probability distribution, while hexagons 610 represent hexagons with a similar feature space but with different marginal probability distributions.

The solutions described herein leverage TL on top of the “Smart Beestrict” concept as depicted and described in FIG. 2 above.

Results from applying the methods described herein using real data from European cities is also described and depicted herein.

For example, the city of Madrid, Spain, was selected as a framework for the practical demonstration of the proposed TL technique. A collection of open data sources related to the proposed application domain is provided in a Table (below), all of which are based on real-time and historical data. In addition, Berlin data sources were explored as a means to enable future TL improvements on top of the “Smart Beestrict” concept. The additional identified sources are: street-wide vehicle counts (hourly update frequencies) classified into different vehicle types, air pollution data including PM₁₀, PM_{2.5}, NOₓ, O₃, CHB, CHT, CO, and weather data (hourly update frequency) including temperature, rain, wind speed, wind direction, and barometric pressure.

| Category | Features | Frequency | Since | Access | Legend |
|---|---|---|---|---|---|
| Air pollution | SO₂, CO, NO, NO₂, PM_{2.5}, PM₁₀, O₃ | Hourly | 2001 | [15, 16] | [17] |
| Noise pollution | Laeq, LAS01, LAS10, LAS50, | Daily | 2014 | [18, 19] | [20] |
| | LAS90, LAS99 | | | | |
| Weather | T, RH, P, wind speed/dir., | Hourly | 2019 | [21, 22] | [23] |
| | irradiation, rain | | | | |
| Parks, gardens | Lon/lat, district, address, surface | Yearly | 2018 | [24] | — |
| Traffic | Lon/lat, intensity, congestion, avg | Hourly | 2013 | [25] | [26] |
| | speed | | | | |
| Night pubs | Open hours, longitude, latitude, id | Hourly | 2016 | [27] | — |

Different data processing steps were used on top of the raw data, as openly available, for both cities Madrid and Berlin. The data is from the entire year 2022. Different dataset versions were processed for each of the data sources to be published to Scorpio using a NGSI-LD client in order to make them available to be reused for future projects or demonstrations. In all cases, GeoPandas DataFrames (found at <https://geopandas.org/en/stable/docs/reference/api/geopandas.GeoDataFrame.html>) were used for dataset generation, where every data sample was linked to a specific longitude, latitude, and shapely point geometry using different Jupyter Notebooks. The location of each notebook is referenced close to its related results.

All original raw data sources were translated to English and structured into a ML readable format. Time series data was also filtered so as to guarantee the absence of long gaps or inconsistencies undermining prediction's performance. This dataset was generated before applying temporal and spatial data interpolation (step 2 in FIG. 2) so as to ensure data is published to Scorpio as made available by the data provider.

This processing step was conducted for all the relevant Madrid data sources in the example (traffic intensity, traffic load, average traffic speed, temperature, relative humidity, irradiation, rain, barometric pressure, wind speed, and wind direction, SO₂, CO, NO₂, NO₂, PM_{2.5}, PM₁₀, and O₃), and for Berlin air-quality data sources.

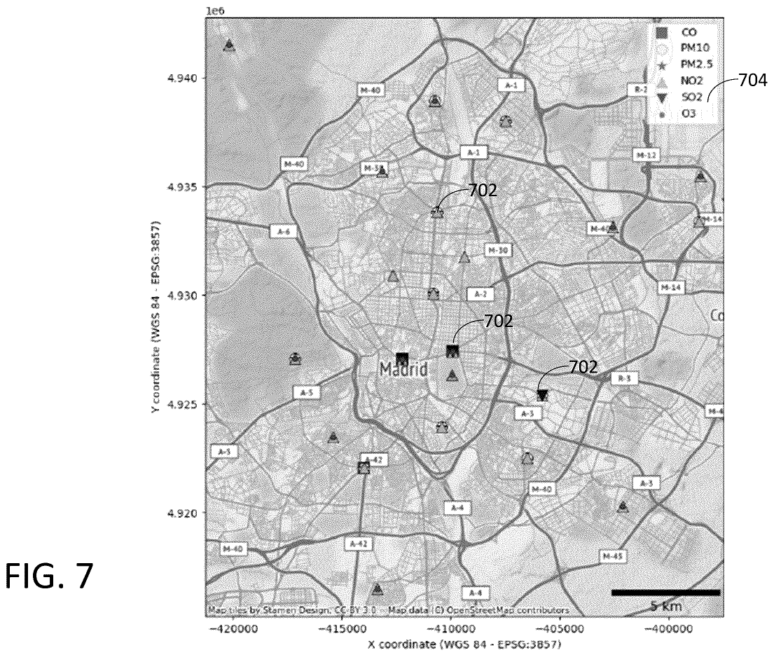

Finally, data was mapped to their respective location by identifying different station types (one per feature being measured). FIG. 7 shows an example of air quality measurement stations 702 mapped to their actual location in the city of Madrid, although this procedure was conducted for the remaining data in Madrid and air quality data in Berlin city (PM₁₀, PM_{2.5}, NOₓ, O₃, CHB, CHT, CO). The key 704 of FIG. 7 describes the various air quality data collected at each station 702.

This GeoPandas DataFrame was obtained after computing temporal data augmentation, so as to guarantee all time series collected from different measurement stations were aligned in time. Specifically, re-sampling periods of 15 minutes were applied and missing values were obtained through linear interpolation. In cases where significant time gaps existed, such as the case of M30 traffic stations that are discontinued during entire months, the resulting times series were automatically discarded.

This resulted, for all features, in 35,040 data samples per measurement station. In the case of weather data, given a limited number of available measurement stations after filtering those with significant gaps, data was spatially augmented to the entire hexagonal grid system before publishing to Scorpio Broker. To do so, Inverse Distance Weighting (IDW2) was used. Further detail on this interpolation is provided below, where hexagon-based aggregation is computed.

Lastly, following the proposed pipeline in FIG. 2, data was aggregated at the hexagon level. To do so, the mean value of every sample measured at a certain time and hexagon boundary was computed and published to Scorpio to enable hexagon-based ML developments.

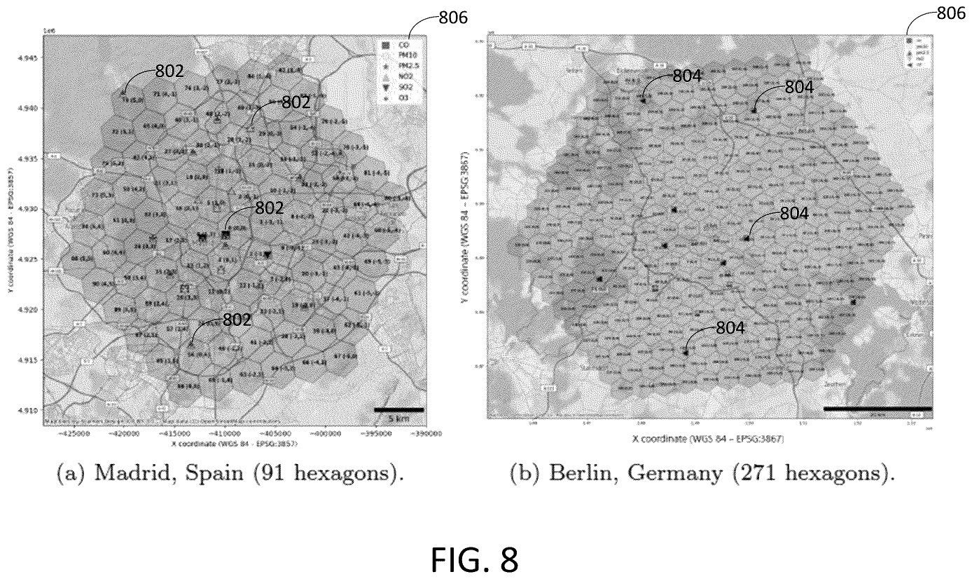

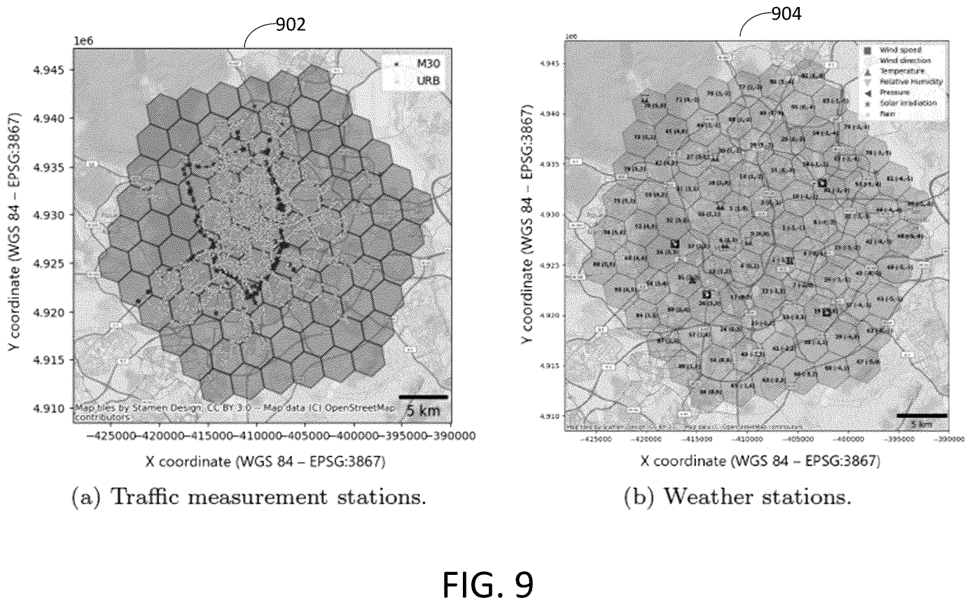

FIG. 8 shows two examples, (a) and (b), which depict the generated grid for the cities of Madrid and Berlin, respectively, and the actual location of air quality measurement stations in each of the cities 802 and 804. FIG. 8 depicts the mapping of air pollution measurement stations from different European cities to hexagonal reference grids. Keys 806 describe the various features that are captured by each sensors 802 and 804. FIG. 9 depicts the actual location of traffic measurement stations 902 as of January 2022 and weather stations 904 for the city of Madrid.

Hexagonal grids were developed using Uber's H3 Hexagonal Hierarchical Geospatial Indexing System (<https://github.com/uber/h3>), for which the following script was developed:cgarrido/hexagonal_grid.ipynb. Hexagonal-based geospatial sectorization might result in more realistic results for data analytics purposes than that obtained through political or administrative boundaries (e.g., districts, cities or countries) where the comparison of variable-size areas or road-traffic distances can result into unbalanced prediction results. Additionally, compared to squares or triangles, hexagons guarantee the same distance between a center-point and its neighbors (<https://www.uber.come/en-DE/blog/h3>).

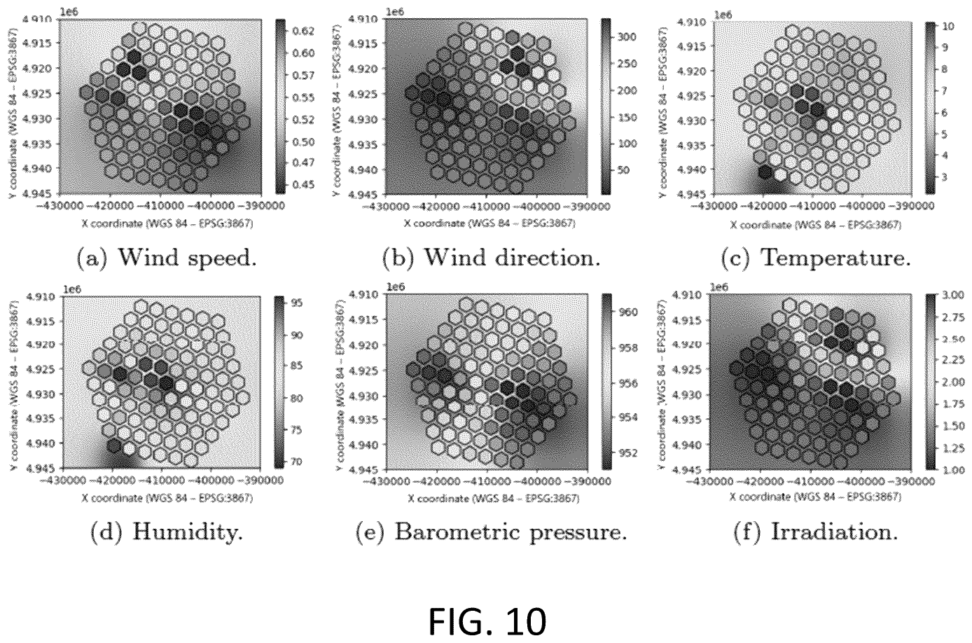

Regarding spatial weather data interpolation, IDW was applied for obtaining a different time series interpolated heat map for each feature (wind speed, wind direction, temperature, humidity, barometric pressure, and irradiation) and sample (35,040). That translates in 210,240 heat maps being generated per hexagon, which results in a total number of 19,131,840 weather samples combining interpolated and actual ones. Different hyperparameters were tested for power and resolution in simple_idw function, which were finally set up to 2 and 10 respectively. The interpolation result is shown in FIG. 10 for a single data sample and each of the features being spatially augmented. FIG. 10 depicts heat maps of different features from which the clustering can then be computed.

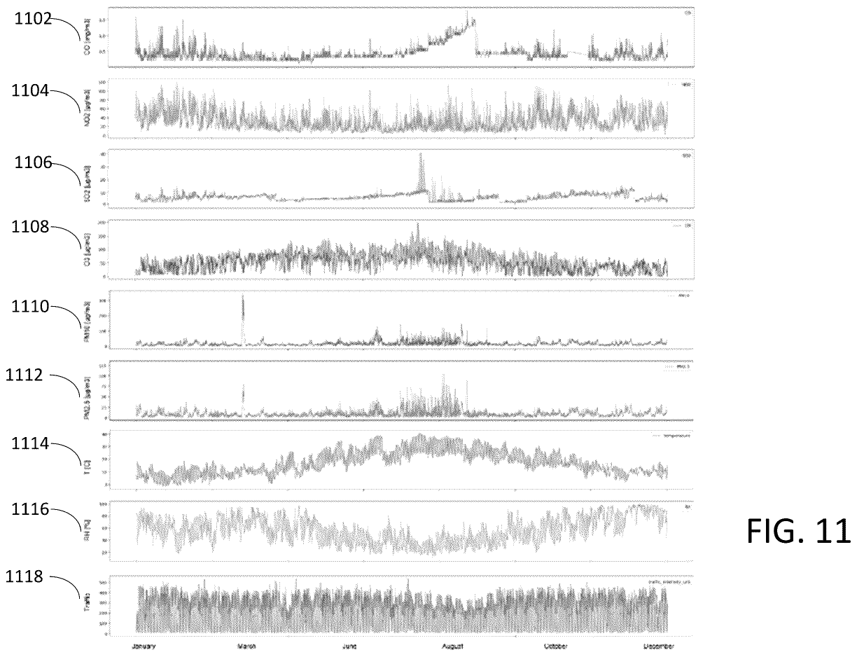

FIG. 11 depicts multivariate time series data from a single hexagon after data preprocessing and aggregation. FIG. 11 depicts an example of the obtained multi-variate time series data for a single hexagon including: CO, NO₂, SO₂, O₃, PM₁₀, PM_{2.5}, temperature, relative humidity, and traffic (1102, 1104, 1106, 1108, 1110, 1112, 1114, 1116, and 1118 respectively).

Having generated the aggregated version of all ground truth and context features in the city of Madrid, the latter were used for identifying different similarity-based clusters. The similarity metric selected to do so was the Euclidean distance, since previous processing had been carried out on the multivariate time series data to guarantee a common time resolution, length, and alignment.

As described above with reference to FIG. 2, single-variate time series clustering is applied for the most relevant features identified at the source hexagon 0. This was done using Random Forest's (RF) feature importance parameter, which pointed to wind speed, temperature, traffic load, and relative humidity (the obtained feature importance for each prediction target can be accessed in JupyterLab instance). In all cases, clustering was carried out on top of high-dimensional data including a total of 35,040 samples per feature.

In order to decide the total number of clusters to be generated for each of the features a Silhouette score from sklearn (<https://scikit-learn.org/stable/modules/generated/sklearn.metrics.silhouette_score.html>) is used, which ranges from −1 (worst similarity) to 1 (highest similarity). First, when the Silhouette score of one or more clusters is lower than the average Silhouette score of all clusters, this number of clusters is declared invalid. Second, from the remaining number of clusters, the one resulting in a highest Silhouette score was selected. The example script from sklearn needed to be adapted for time series clustering so as to represent the similarity of each of the time series being received as an input and the resulting time series centroid of each cluster as an output. The developed script to do so is provided under cgarrido/clustering.ipynb, where the hyper parameters used can be found.

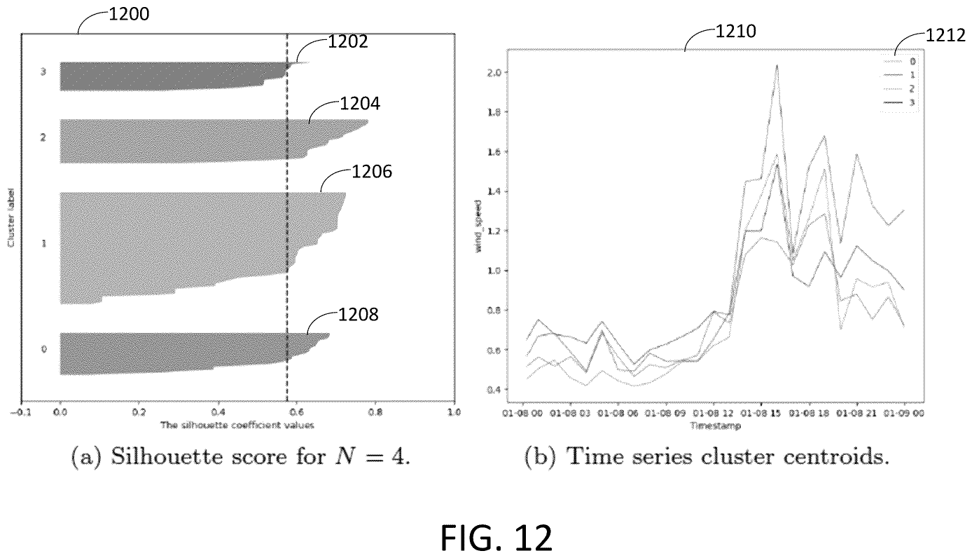

FIG. 12 depicts an example 1200 of the number of clusters (1202-1208) selected for time series clustering based on wind speed, where the two previously-defined criteria are met for N=4. FIG. 12a represents the average Silhouette score obtained compared to that of every element for the cluster, and FIG. 12b provides a visualization 1210 of the four resulting centroids considering data from a single day as a means of exemplification. The key 1212 represents cluster labels from FIG. 12a.

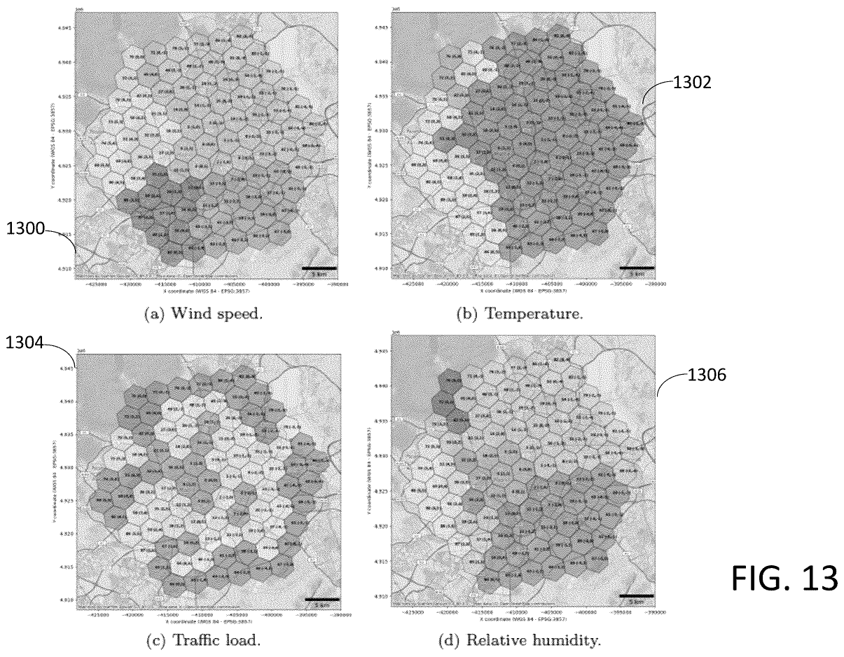

The resulting representation of Madrid's city according to the different single variate clustering conducted are shown in FIG. 13, where a transformation was applied so as to guarantee that a lower cluster number always referred to higher positive impact on air quality and vice versa. In FIG. 13, therefore, orange-color “Beestricts” identify worse air quality indices, while yellow ones identify better air quality ones. FIG. 13 depicts orange and yellow colored quality indices with reference to different features such as wind speed 1300, temperature 1302, traffic load 1304, and relative humidity 1306.

In order to validate a proposed solution as described herein, NO₂ was selected as a target feature being predicted in the city of Madrid, although the provided codes can be used for any of the available ground truth features described previously and shown in FIG. 13.

Once aggregated the available data sources, and having used context-related ones such as weather or traffic for generating different “Beestrict” representations of the city, as shown in FIG. 2, different ML models were trained on hexagons where ground truth was available. Specifically, RF regression, Support Vector Regression (SVR) and Multilayer Perceptron (MLP) were trained using 80% of the data and tested using the remaining 20%. To do so, data was shuffled and scaled while, of the different hyperparameters tested, those resulting in more accurate predictions were selected. Further detail can be found in cgarrido/predict_modeltunning_crossvalidation.ipynb, which performs model training and cross-validation for a single given hexagon.

In order to evaluate the performance of each model, the following metrics were used: Root Mean Squared Error (RMSE), Mean Squared Error (MSE), and R². The RMSE measures the error in the same units as the target feature, and the MSE in units referring to the square of the target feature (it penalizes outliers errors more severely). To measure the accuracy of the regression models tested, MSE was compared to the variance of the test set (RMSE should be compared with the standard deviation), so that variances significantly higher than MSEs translate in suitable model performance. Finally, R² serves as a measure of the goodness of fit of the model.

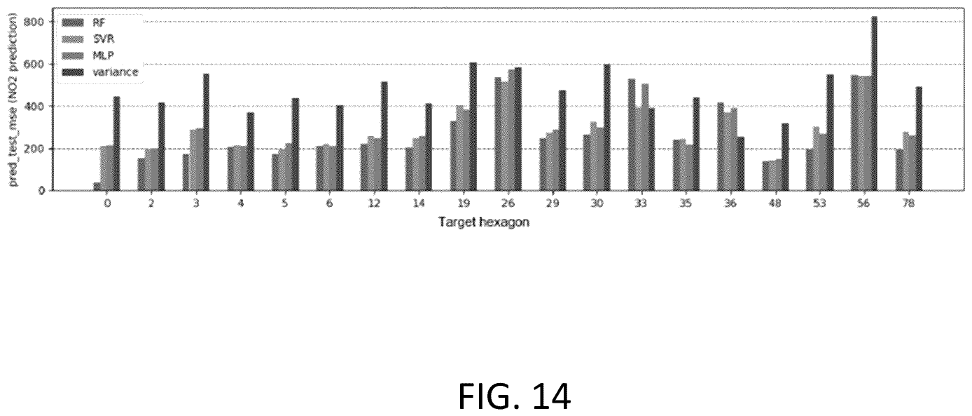

FIG. 14 shows the MSE obtained for each of the machine learning models (Random Forest (RF), Support Vector Machine (SVR), Multilayer Perceptron (MLP)) trained on the same source hexagon (0) and transferred to all remaining hexagons. The selected hyper parameters can be found in the JupyterLab server. The variance of each of the test sets is also displayed in the bar plot in order to identify those where a small variance-to-MSE distance indicates poor reusability of the source model. This experiment was run for all hexagons acting as source, which helped to obtain some preliminary conclusions with regard to model selection. After cross-validation of all source to all target hexagons, RF achieved the best results compared to those of SVR and MLP for both MSE and R² scores. More detailed results can be found in cgarrido/results/NO2/raw_results/N_alltargets.pkl, where independent files are used to store the MSE, RMSE and R² scores of all the conducted experiments regarding NO₂ predictions (N is the source hexagon number where the model was trained). The experimental results showed improvement over R² scores by the selection of a correct source hexagon for the correct target hexagon. Using the methods described herein for obtaining a spatiotemporal NO₂ model, we are able to improve the spatial coverage to up to 145%, while achieving improvements in R² score ranging from 0.41 to 0.70. The methods described herein were also able to show, in the experimental results, an improvement to the reusability of trained prediction models for transfer in 17 out of 19 scenarios represented by different intra-cluster regions used for training.

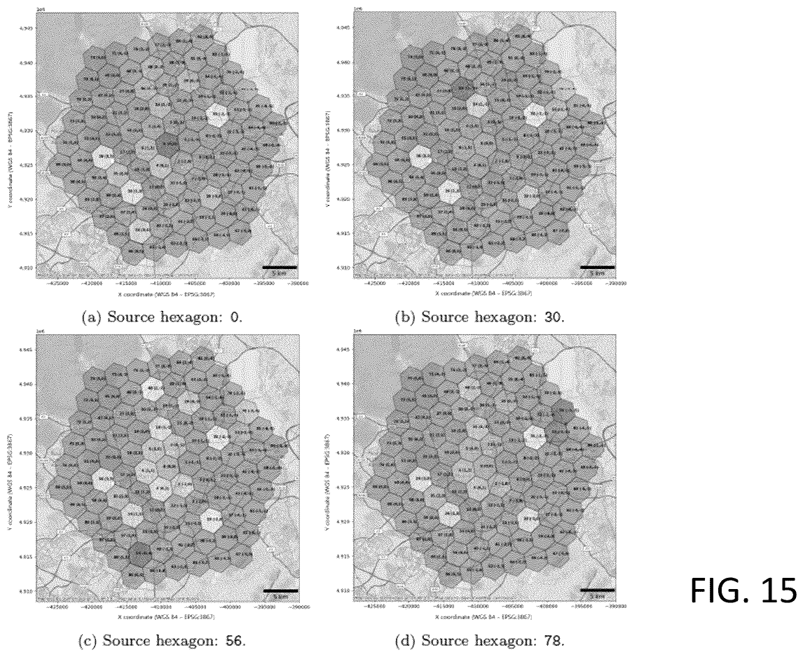

In view of the results shown in FIG. 15 (and the overall results included in JupyterLab server), there are significant reusability differences between different source and target hexagons. For instance, while the RF model trained on hexagon 0 shows a fair reusability on hexagons 3 or 30, it has a low suitability for being transferred to hexagons 26 or 33 (either because of source and target having limited similarity or because of the presence of outliers in any of them related to calibration of sensor maintenance). In order to graphically show some representative examples, FIG. 15 displays the R² score for four different source hexagons and all possible target ones using only the RF model, which already demonstrated to achieve better results). FIG. 15 includes a caption represented a given number for the source hexagon (e.g., 0, 30, 56, and 78). The darker the shade of the hexagons in each graph represent that a given source is more reusable for a target hexagon whereas a less darker shade or grey means that the given source is less reusable (e.g., the performance of the machine learning model suffers in the grey or less darker shaded hexagons).

Again, the high differences found in terms of reusability across different target hexagons points out the need for an automated mechanism able to discover transferable hexagons in different cities, which follows the proposed concept and pipeline shown in FIG. 2.

In order to discover different subsets of hexagons potentially improving the reusability of the pre-trained ML models, different time series clustering aggregation strategies where proposed and tested. These are described as:

Most relevant feature. According to the feature-importance results obtained through RF regression for a given source hexagon (0), where wind speed showed the highest relevance for NO2 predictions. A variant of this alternative could be implemented through feature-importance-based weighing of single-variate clustering results.

Soft intersection. This technique consists of generating aggregated clusters based on those hexagons that, in all single-variate clustering iteration except one, were assigned to the same cluster.

Strict intersection. This technique is based on the previous, which considers as part of the same cluster all hexagons that, in all cases (e.g., temperature, wind speed, humidity, etc.), were aggregated to the same cluster.

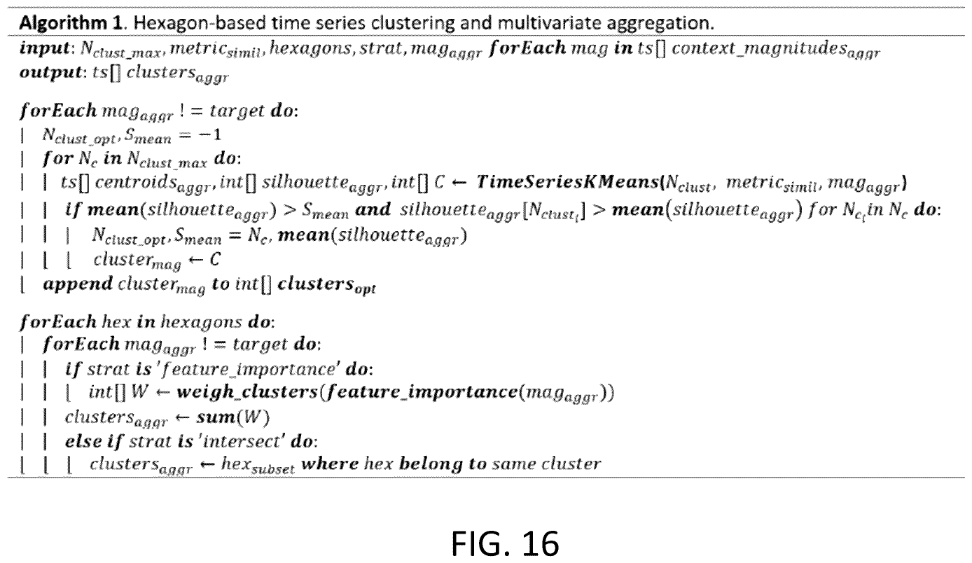

To do so, the script cgarrido/reusability_results.ipynb was developed. For a given cluster aggregation technique, this script returns the set of selected hexagons where potential reusability of a specific pre-trained model is expected. FIG. 16 shows the developed pseudocode related to steps 4 and 5 from FIG. 2 where multivariate time series clustering aggregation is proposed. The methods and techniques described herein, nevertheless, are not limited to these three strategies but can be applied with many other alternatives.

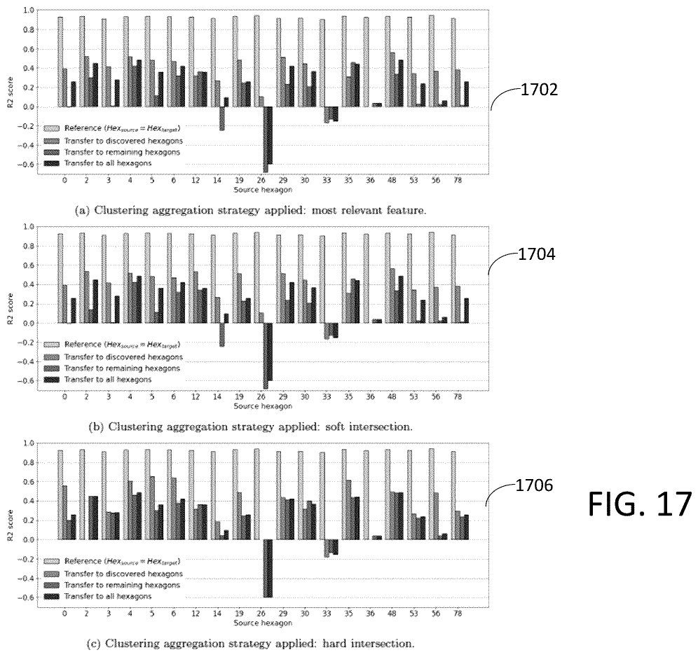

All the metrics obtained in previous steps (MSE, RMSE and R²), part of which are shown in FIGS. 14 and 15, were collected to reach conclusions regarding the suitability of the proposed hexagon-discovery strategies. FIG. 17 shows cross-validation mean R² scores obtained through:

Applying the trained model in the same source and target hexagon.

Applying the trained model on the discovered subset of hexagons with potential reusability, as identified through most relevant feature, soft intersection, and hard intersection strategies (FIGS. 17b, 17c and 17a respectively).

Applying the trained model on the remaining not-discovered hexagons.

Applying the trained model on all hexagons (source being excluded).

From the experiments shown in FIG. 17, on average, the three strategies proposed improved on average the reusability of pre-trained models through automatic discovery of reusable hexagons. The improvements achieved when reusing the models on the discovered hexagons with respect to reusing them on all available hexagons range from 56.91% (most-relevant feature) to 69.01% (strict intersection). The highest goodness-of-fit results were obtained with strict intersection (R² equal to 0.4031 versus 0.3742 in the case of feature-importance and 0.3885 in the case of soft intersection). Additionally, the most accurate single-model results (those measured for a single source hexagon number in FIG. 14) were also achieved with strict intersection. Specifically, models trained on hexagon 5 achieved the best reusability for the “Beestrict” shared with hexagons 0, 4, and 6 (R² equal to 0.6541).

While no significant accuracy differences were identified when applying each of the strategies proposed for the different subsets of hexagons discovered, some differences exist regarding those hexagons that were categorized outside the clusters. Specifically, the strict intersection strategy led to an average R₂ score of 0.2228 for those hexagons left outside the discovered subset, while soft intersection and most-relevant feature strategies obtained significantly lower R₂ scores (0.0971 and 0.1079, respectively), which is closest to expected. FIG. 17 depicts three different strategies applied to pre-trained models, 1702, 1704, and 1706. Strategy 1702 includes applying a clustering aggregation strategy for the most-relevant feature. Strategy 1704 includes applying a clustering aggregation strategy in the case of soft intersection. Strategy 1706 includes applying a clustering aggregation strategy with a hard intersection. In each section of data of the bar graph of FIG. 17, the first bar is associated with a reference (Hex_{source}=Hex_{target}), the second bar represents transfer to discovered hexagons, the third bar represents transfer to remaining hexagons, and the fourth bar represents transfer to all hexagons.

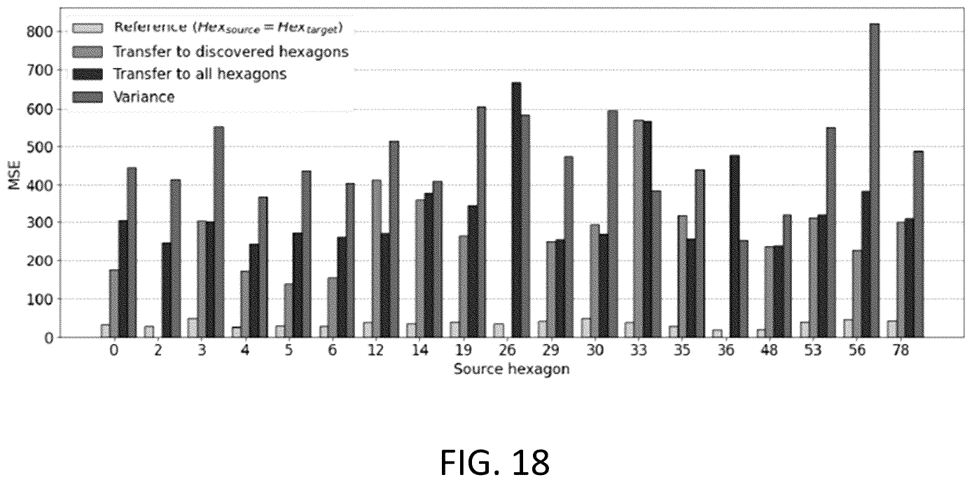

FIG. 18 depicts, as a representative case, the MSE obtained after cross-validation of source-to-all-target hexagons in the case of applying strict intersection (all results for the different strategies and models tested can be accessed in the provided JupyterLab under cgarrido/results/NO2/plots/).

In FIG. 18, the MSE obtained through transferring the pre-trained model to hexagons inside the discovered “Beestrict” is compared to the test variance as a means to identify outliers. Our hexagon discovery pipeline was able to reduce the MSE with respect to the average MSE in 12 out of 16 training scenarios (hexagon-based). Again, the best results were obtained for the cluster (Beestrict) composed of hexagons 0, 4, 5, and 6, where the obtained MSE was halved. In each section of data of the bar graph of FIG. 18, the first bar is associated with a reference (Hex_{source}=Hex_{target}), the second bar represents transfer to discovered hexagons, the third bar represents transfer to all hexagons, and the fourth bar represents variance.

Some specific cases provide relevant insights for future improvements on hexagon discovery for transfer learning. Significant errors in hexagon discovery can be observed for hexagons 3, 14, 30 and 33, which can be attributed to the existence of urban-form elements and factors such as the presence of M30 road. Similarly, hexagons 29 and 78 present high inaccuracies when transferring to discovered hexagons, which might be influenced by the existence of parks or airports, respectively.

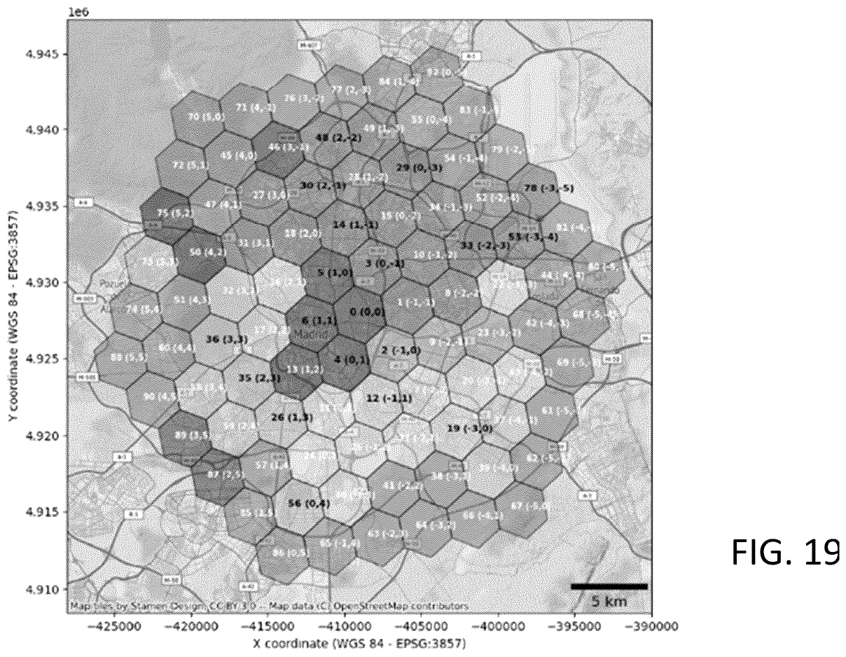

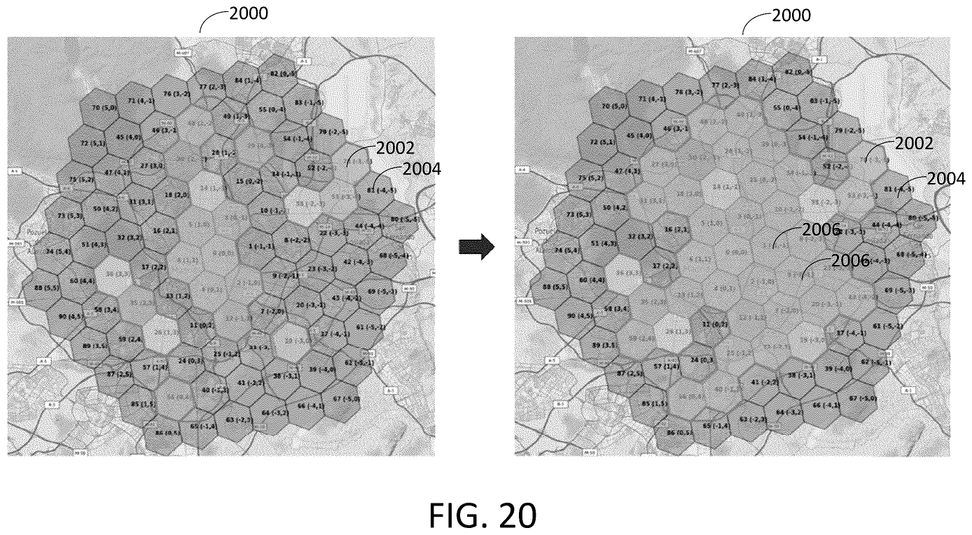

FIG. 19 shows the obtained representation of the city based on multivariate clustering at hexagon level by applying the strict intersection strategy. FIG. 19 depicts clusters identified for TL in the city of Madrid (Spain) using the methods and techniques described herein. The various shadings of hexagons in FIG. 19 represent a cluster index, the bold numbers represent available data, and the white numbers represent numbers predicted through the methods described herein. Based on the available hexagons for training inside each of the obtained clusters, an example of the city knowledge coverage increase in terms of NO₂ is provided in FIG. 20. FIG. 20 depicts the city of Madrid 2000 with hexagons 2002, which represent hexagons with sensors, and hexagons 2004, which represent hexagons without sensors for a NO₂ feature. FIG. 20 also depicts the same city of Madrid 2000 with hexagons 2002 and 2014 but with TL discovered hexagons 2006 or increased knowledge coverage of NO₂ via the methods and techniques described herein.

### REFERENCES

Zhuang F, Qi Z, Duan K, Xi D, Zhu Y, Zhu H, et al., A Comprehensive Survey on Transfer Learning, Proceedings of the IEEE, 109(1):43-76 (2020).
Pan S J, Yang Q., A survey on Transfer Learning. IEEE Transactions on knowledge and data engineering, 22(10):1345-59 (2010).
Wang L, Guo B, Yang Q., Smart city development with urban transfer learning, Computer, 51(12):32-41 (2018).
AghaKouchak A, Pan B, Mazdiyasni O, Sadegh M, Jiwa S, Zhang W, et al., Status and prospects for drought forecasting: opportunities in artificial intelligence and hybrid physical—Statistical forecasting, Philosophical Transactions of the Royal Society A., 380(2238):20210288 (2022).
Zhao G, Pang B, Xu Z, Cui L, Wang J, Zuo D, et al., Improving urban flood susceptibility mapping using transfer learning. Journal of Hydrology, 602:126777 (2021).
Weiss K, Khoshgoftaar T M, Wang D., A Survey of Transfer Learning, Journal of Big data, 3(1):1-40 (2016).
Gonzalez-Vidal A, Mendoza-Bernal J, Niu S, Skarmeta A F, Song H., A Transfer Learning Framework for predictive energy-related scenarios in Smart Buildings, IEEE Transactions on Industry Applications, (2022).
Ghasemi K, Hamzenejad M, Meshkini A., The spatial analysis of the livability of 22 districts of Tehran Metropolis using multi-criteria decision making approaches, Sustainable cities and society, 38:382-404 (2018).
Khorrami Z, Ye T, Sadatmoosavi A, Mirzaee M, Fadakar Davarani M M, Khanjani N., The indicators and methods used for measuring urban livability: a scoping review, Reviews on environmental health, 36(3):397-441 (2021).
Kumar Jha S, Kumar M, Arora V, Tripathi S N, Motiram Motghare V, Shingare A, et al., Domain adaptation based deep calibration of low-cost PM2.5 sensors, IEEE Sensors Journal, (2021).
Honarvar A R, Sami A., Towards sustainable smart city by particulate matter prediction using urban big data, excluding expensive air pollution infrastructures, Big data research, 17:56-65, (2019).
Digitale Platform Stadtverkehr. Einfuhrung der Digitalen Plattform Stadtverkehr; Accessed: 23 Jun. 2023. <https://www.berlin.de/sen/uvk/mobilitaet-und-verkehr/verkehrspolitik/forschungsund-entwicklungsprojekte/laufende-projekte/digitale-plattformstadtverkehr-1099960.php.>
Berlin Luftgutemessnetz. Berliner Luftdaten; Accessed: 23 Jun. 2023, <https://luftdaten.berlin.de/pollution/overview>.
Meteostat. Berlin weather data; Accessed: 23 Jun. 2023, <https://meteostat.net/en/station/10382?t=2022-01-01/2022-12-31>.
Open Data Portal from Madrid's City Hall. Air quality—Daily data since 2001; Accessed: 23 Mar. 2023, <https://datos.madrid.es/portal/site/egob/menuitem.c05c1f754a33a9fbe4b2e4b284fla5a0/?vgnextoid=aecb88a7e2b73410VgnVCM2000000c205a0aRCRD&vgnextchannel=374512b9ace9f310VgnVCM100000171f5a0aRCRD&vgnextfmt=default>.
Open Data Portal from Madrid's City Hall, Location of Air Quality Control Stations; Accessed: 23 Mar. 2023, <https://datos.madrid.es/portal/site/egob/menuitem.c05c1f754a33a9fbe4b2e4b284fla5a0/?vgnextoid=9e42c176313eb410VgnVCM1000000b205a0aRCRD&vgnextchannel=374512b9ace9f310VgnVCM100000171f5a0aRCRD&vgnextfmt=default>.
Department of Sustainability and Environmental Control from the city of Madrid, Air Quality Data Interpreter; Accessed: 23 Mar. 2023, <https://datos.madrid.es/FWProjects/egob/Catalogo/MedioAmbiente/Aire/Ficheros/Interprete_ficheros_\%20calidad_\%20del_\%20aire_global.pdf>.
Open Data Portal from Madrid's City Hall, Noise pollution—Daily data since 2014; Accessed: 23 Mar. 2023, <https://datos.madrid.es/portal/site/egob/menuitem.c05c1f754a33a9fbe4b2e4b284fla5a0/?vgnextoid=b8c427a272e4e410VgnVCM2000000c205a0aRCRD&vgnextchannel=374512b9ace9f310VgnVCM100000171f5a0aRCRD&vgnextfmt=default>.
Open Data Portal from Madrid's City Hall, Location of Noise Pollution Control Stations; Accessed: 23 Mar. 2023, <https://datos.madrid.es/portal/site/egob/menuitem.c05c1f754a33a9fbe4b2e4b284fla5a0/?vgnextoid=b05a79ea1770b410VgnVCM100000b205a0aRCRD&vgnextchannel=374512b9ace9f310VgnVCM100000171f5a0aRCRD&vgnextfmt=default>.
Department of Sustainability and Environmental Control from the city of Madrid, Noise Pollution Data Interpreter; Accessed: 23 Mar. 2023, <https://datos.madrid.es/FWProjects/egob/Catalogo/MedioAmbiente/Ruido/Ficheros/INTER PRETE\%20DE\%20ARCHIVO\%20DE\%20DATOS\%20DIARIOS\%20RUIDOS.pdf>.
Open Data Portal from Madrid's City Hall, Meteorology hourly data since 2019; Accessed: 23 Mar. 2023, <https://datos.madrid.es/sites/v/index.jsp?vgnextoid=fa8357cec5efa610VgnVCM1000001d4a900aRCRD&vgnextchannel=374512b9ace9f310VgnVCM100000171f5a0aRCRD>.
Open Data Portal from Madrid's City Hall, Location of Weather Control Stations; Accessed: 23 Mar. 2023, <https://datos.madrid.es/portal/site/egob/menuitem.c05c1f754a33a9fbe4b2e4b284fla5a0/?vgnextoid=2ac5be53b4d2b610VgnVCM2000001f4a900aRCRD&vgnextchannel=374512b9ace9f310VgnVCM100000171f5a0aRCRD&vgnextfmt=default>.
Department of Sustainability and Environmental Control from the city of Madrid, Weather Data Interpreter; <https://datos.madrid.es/FWProjects/egob/Catalogo/MedioAmbiente/DatosMeteorologicos/Fi cheros/Interpretaci\%C3\%B3n_datos_meteorologicos.pdf>.
Open Data Portal from Madrid's City Hall. Main parks and gardens; Accessed: 23 Mar. 2023, <https://datos.madrid.es/portal/site/egob/menuitem.c05c1f754a33a9fbe4b2e4b284fla5a0/?vgnextoid=dc758935dde13410VgnVCM2000000c205a0aRCRD&vgnextchannel=374512b9ace9f310VgnVCM100000171f5a0aRCRD&vgnextfmt=default>.
Open Data Portal from Madrid's City Hall, Traffic historical data since 2013; Accessed: 23 Mar. 2023, <https://datos.madrid.es/portal/site/egob/menuitem.c05c1f754a33a9fbe4b2e4b284fla5a0/?vgnextoid=33cb30c367e78410VgnVCM1000000b205a0aRCRD&vgnextchannel=374512b9ace9f310VgnVCM100000171f5a0aRCRD&vgnextfmt=default>.
Department of Sustainability and Environmental Control from the city of Madrid, Traffic Data Interpreter; <https://datos.madrid.es/FWProjects/egob/Catalogo/Transporte/Trafico/ficheros/Estructura_DS_Contenido_Trafico_Historico.pdf>.
Open Data Portal from Madrid's City Hall, Leisure facilities in the city of Madrid; Accessed: 23 Mar. 2023, <https://datos.madrid.es/portal/site/egob/menuitem.c05c1f754a33a9fbe4b2e4b284fla5a0/?vgnextoid=54d4a73970504510VgnVCM2000001f4a900aRCRD&vgnextchannel=374512b9ace9f310VgnVCM100000171f5a0aRCRD&vgnextfmt=default>.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for spatiotemporal transfer learning, the computer-implemented method comprising:
aggregating sectors of an area using preprocessed data from one or more data sources;
clustering the sectors based on different representations obtained for each context feature associated with each of the sectors;
identifying and aggregating one or more context features from a plurality of context features that have a higher impact on a target feature to be predicted than other ones of the context features of the plurality of context features to obtain a representation of the area;
selecting, using the representation of the area, a particular sector within each of the clustered sectors based on similarity to a respective centroid of the cluster to generate a set of particular sectors; and
training a model associated with a source sector of the set of particular sectors.

2. The computer-implemented method of claim 1, wherein training the model includes training a plurality of models associated with the source sector and/or using ground truth data of the source sector, the method further comprising:
identifying one of the models with a highest accuracy from the plurality of models using cross-validation; and
updating the trained model associated with the source sector using shifting based on existing urban-form factors and/or seasonal shifting using time-dependent events.

3. The computer-implemented method of claim 2, wherein the impact of each of the context features is determined by computing feature importance for each of the context features by applying each of the context features to one of the models and determining how much each of the context features contribute to decreasing uncertainty of the respective model.

4. The computer-implemented method of claim 1, wherein the source sector is selected for training the model based on having a highest similarity to the respective centroid of the respective cluster associated with the source sector relative to other ones of the particular sectors that have ground truth data.

5. The computer-implemented method of claim 1, further comprising predicting, using the trained model, the target feature for one of the sectors that is different from the source sector and does not have ground truth data.

6. The computer-implemented method of claim 1, wherein data in the one or more data sources is obtained via a web crawling service or device discovery.

7. The computer-implemented method of claim 1, wherein the target feature and the context features that are identified and aggregated to obtain the representation of the area are each related to air quality of the area.

8. The computer-implemented method of claim 1, wherein the data is preprocessed by at least checking the language and format of the data, performing temporal data augmentation to the data, and performing spatial augmentation of context data.

9. The computer-implemented method of claim 1, wherein the sectors of the area are identified based on a geographical location of a sensor device, each of the sectors representing geometrical boundaries for the area.

10. The computer-implemented method of claim 1, wherein clustering the sectors is further based on a maximum number of clusters to iterate and a similarity metric for computing Silhouette scores.

11. The computer-implemented method of claim 1, wherein selecting the particular sector within each cluster of the clustered sectors is further based on scaling different time series data inside each clustered sector, computing a Silhouette score for each sector of each clustered sector, determining the centroid for each cluster based on scaled context data, and selecting the particular sector within a certain distance of the centroid for the cluster based on the Silhouette score for the particular sector.

12. The computer-implemented method of claim 1, wherein the data from the one or more data sources includes sensor data from one or more sensors geographically located within the area.

13. The computer-implemented method of claim 1, wherein the preprocessed data includes a common format and sampling frequency from the one or more data sources.

14. A computer system for spatiotemporal transfer learning, the computer system comprising one or more hardware processors which, alone or in combination, are configured to provide for execution of the following steps:
aggregating sectors of an area using preprocessed data from one or more data sources;
clustering the sectors based on different representations obtained for each context feature associated with each of the sectors;
identifying and aggregating one or more context features from a plurality of context features that have a higher impact on a target feature to be predicted than other context features of the plurality of context features to obtain a representation of the area;
selecting, using the representation of the area, a particular sector within each of the clustered sectors based on similarity to a respective centroid of the cluster to generate a set of particular sectors; and
training a model associated with a source sector of the set of particular sectors.

15. A tangible, non-transitory computer-readable medium having instructions thereon which, upon being executed by one or more processors, provide for spatiotemporal transfer learning by execution of the following steps:
aggregating sectors of an area using preprocessed data from one or more data sources;
clustering the sectors based on different representations obtained for each context feature associated with each of the sectors;
identifying and aggregating one or more context features from a plurality of context features that have a higher impact on a target feature to be predicted than other context features of the plurality of context features to obtain a representation of the area;
selecting, using the representation of the area, a particular sector within each of the clustered sectors based on similarity to a respective centroid of the cluster to generate a set of particular sectors; and
training a model associated with a source sector of the set of particular sectors.
